(19) United States
(12) Patent Application Publication
(10) Pub. No.: US 2012/0272894 A1
(43) Pub. Date: Nov. 1, 2012

(54) APPLICATION TOOL FOR UNDERWATER COATINGS

(76) Inventor: Timothy M. Schuster, Bradford, PA (US)

(21) Appl. No.: 13/456,874

(22) Filed: Apr. 26, 2012

Related U.S. Application Data
(60) Provisional application No. 61/479,542, filed on Apr. 27, 2011.

(51) Int. Cl. B05C 1/00

(52) U.S. Cl. 118/264

(57) ABSTRACT

An application tool for applying coatings to surfaces in underwater environments is provided. The application tool includes a hollow tube attached to a hollow chamber. A fixed plate with an application pad on one side is attached to the hollow chamber. Holes are provided through the hollow chamber, plate and application pad. In use, a liquid coating may be pumped through the hollow tube into the hollow chamber, where it then flows through the hole to the surface of the application pad. The coating application tool is particularly useful for applying coatings to underwater surfaces, such as in nuclear power plants.

### PRIORITY APPLICATION

This application claims priority under 35 U.S.C. §119(e) to U.S. Provisional Application No. 61/479,542 filed on Apr. 27, 2011, the contents of which are incorporated herein in their entirety.

### FIELD OF THE INVENTION

The present invention is directed, in one aspect, to an application tool for applying coatings to surfaces in underwater environments. The coating application is particularly useful for applying coatings to underwater surfaces, such as in nuclear power plants. In another aspect, the invention is directed to methods of applying coatings using the application tool.

### BACKGROUND

Coatings are applied to surfaces for various reasons, including for prevention of corrosion or degradation of the substrate, providing a smooth surface, and prevention of the growth of mold or other materials. In many instances, surfaces to be coated are in underwater environments. For example, supports for bridges or offshore platforms often require coating underwater.

In nuclear power generating facilities, coatings are often applied underwater. The water provides shielding from radiation and prevents radioactive particles from becoming air borne. When applying coatings in this environment, it is desirable to apply the coating as quickly as possible to minimize exposure of personnel to radiation.

Tools previously used for underwater application of coatings included roller applicators and hand brushing. Roller application produces a stipple or surface roughness and does not leave a smooth appearance. Assembly of the roller application tool can be complicated and time consuming. In addition, large amounts of coating were sometimes deposited in undesired locations or on surfaces not planned for coating. Multiple applications are often required.

Application of coatings by manual brushing is very difficult and time consuming. In addition, manual brushing can result in inconsistent thickness and a non-uniform appearance.

Accordingly, it would be desirable to have an application tool that is capable of applying a coating to a larger surface area.

### BRIEF DESCRIPTION OF THE FIGURES

FIG. 1a is a cross-sectional side view of one embodiment of the coating application tool.

FIG. 1b is a view of the bottom of one embodiment of the coating application tool showing the coating application pad and holes for allowing coating to flow to the surface of the pad.

FIG. 2 is a top view of one embodiment of the coating application tool, which shows the location of the holes in the chamber. It is understood that the holes are present only on the side of the chamber in contact with the steel plate, and there are no holes in the top of the chamber.

FIG. 3 shows the location of the holes in the chamber in one embodiment of the coating application tool.

FIG. 4 is a top view of one embodiment of the coating application tool.

FIG. 5 is a side view of one embodiment of the coating application tool.

FIG. 6 is a bottom view of one embodiment of the coating application tool.

FIG. 7 is a side view of a second embodiment of the coating application tool.

### DETAILED DESCRIPTION OF THE INVENTION

The present invention relates to a tool for application of coatings. The tool is particularly suited for underwater application of coatings, as in nuclear power generating facilities. The advantages of the application tool include: (1) a more uniform thickness of coating is applied, (2) a smoother surface appearance can be achieved, (3) greater control of the location of the coating avoids application in undesired areas, and (4) a single coat can provide the desired coating thickness, avoiding multiple coating applications. Other advantages of the coating application tool will be apparent to those skilled in the art based upon the detailed description provided below.

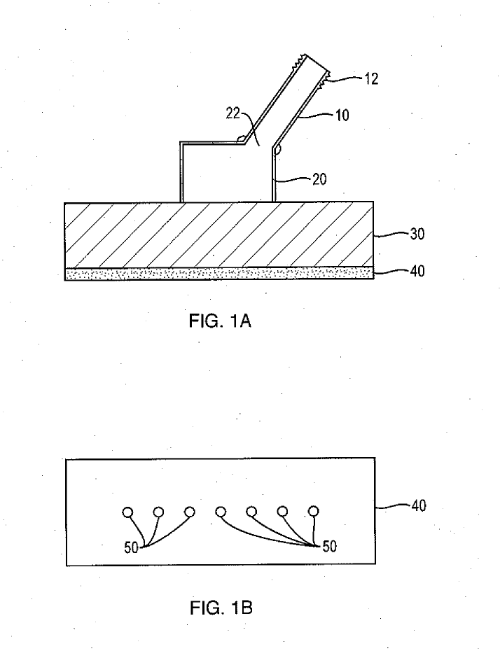

The coating application tool of the present invention is shown generally in FIGS. 1a and 1b. Referring to the side view depicted in FIG. 1a, the application tool comprises a tube or pipe (10) attached to a hollow chamber (20). For purposes of the following description, reference will be made to a pipe, but it will be understood that a tube or any other appropriate hollow structure suitable for allowing the flow of liquid can be used. The pipe (10) may have means, such as threads (12), on the end opposite the hollow chamber for attaching a hose to the tool. The hollow chamber (20) can be a second pipe or any other structure that can contain a volume of liquid. In one embodiment, the pipe and the hollow chamber are made of stainless steel. The invention is not limited in this regard, and any appropriate material may be used, such as other metals or plastics.

The pipe (10) may be attached to the hollow chamber (20) using any means for attachment known to those skilled in the art. Where the pipe and the hollow chamber are stainless steel, the pipe and the hollow chamber may be attached by welding. Depending upon the materials used for the pipe and hollow chamber and the intended use, the pipe and hollow chamber may be attached using an adhesive, such as glue or epoxy, or using fasteners with a gasket.

The hollow chamber has an opening (22) at the location where the pipe is attached to the hollow chamber that allows liquid coating material to flow from the pipe into the hollow chamber. The pipe may be attached to the hollow chamber at an angle to facilitate the use of the tool for application of coatings. In one embodiment, the pipe is attached to the hollow chamber at an angle of 30° to 40°, although any other desired angle may be used.

The hollow chamber (20) is attached to a plate (30). The plate (30) is typically made from the same material as the hollow chamber and pipe. As discussed above, when stainless steel or other metal is used, the hollow chamber may be attached to the plate by one or more welds. Other attachment means discussed above may be used depending upon the materials used and the intended use for the tool.

A coating application pad (40) suitable for applying coatings to a surface is attached to the bottom of the plate (30) opposite the hollow chamber (20). The coating application pad may be a foam pad or a pad with brush type material. In one embodiment, the coating application pad is a rubber foam. The coating application pad may be attached to the bottom of the plate using a suitable adhesive, such as a two part epoxy glue, although the invention is not limited in this regard and any appropriate means of attaching the application pad to the bottom of the plate may be used.

As shown in the bottom view of the coating application tool shown in FIG. 1b, a plurality of holes (50) are drilled through the hollow chamber, the plate and the coating application pad to allow the liquid coating to flow from the hollow chamber to the outer surface of the coating application pad where it can be applied to the surface to be coated.

The liquid coating is delivered to the coating application tool using a system that is known to those skilled in the art. Generally, a pump is used to transfer the coating from a tank or other storage container. The liquid coating is typically pumped through a hose. The outlet end of the hose is attached to the coating application tool. The liquid coating material is pumped through the pipe and flows into the hollow chamber. The coating material flows through the holes to the surface to be coated, and is smoothed on the surface by the application pad.

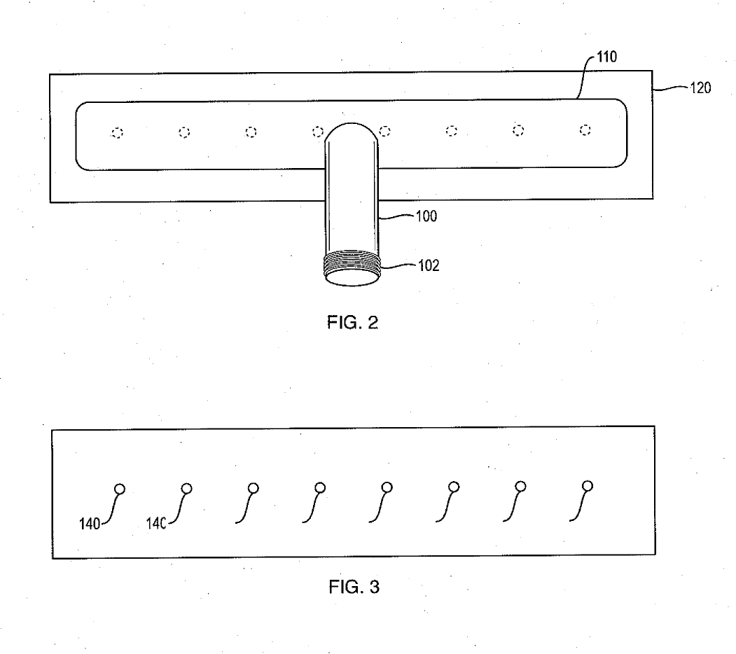

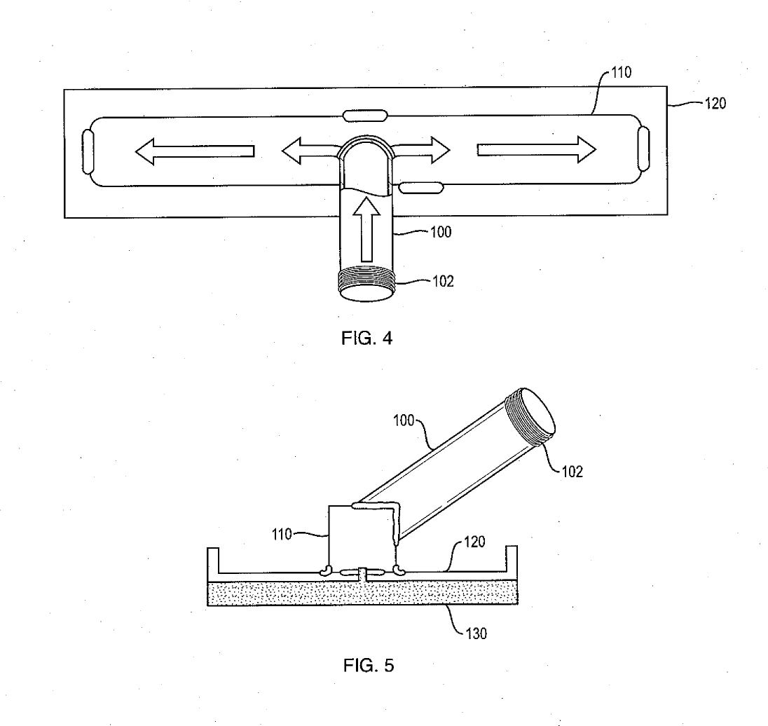

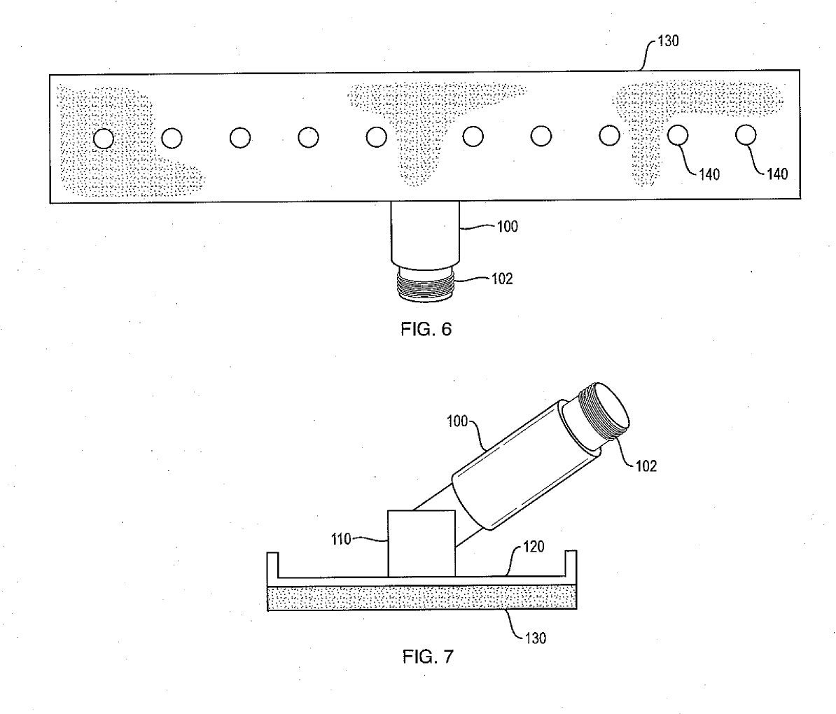

One embodiment of the invention is shown in FIGS. 2-7. A ⅜ inch diameter pipe (100) is welded to a hollow chamber which in this embodiment is comprised of a square hollow pipe (110). Pipe (100) has a threaded end (102) to connect to a ⅜ inch hose fitting. The square hollow pipe (110) is welded closed at both ends. A hole is ground in the square hollow pipe at the location where pipe (100) is welded to the square hollow pipe (110) to allow the coating to flow through the pipe (100) into square hollow pipe (110).

Square hollow pipe (110) is welded to one side of stainless steel plate (120). Stainless steel plate may be 3 inches to 18 inches long. In one embodiment, stainless steel plate is 18 inches long and 4 inches wide. In this embodiment, square hollow pipe is about 17 inches long to allow about ½ inch from the edge of the stainless steel plate to the end of hollow square tube. The stainless steel plate may be any thickness desired. In the embodiment of FIGS. 2-6, the stainless steel plate is 16 gauge or 22 gauge stainless steel plate. The plate may be bent at the edge to provide structural support.

Coating application pad (130) is fixedly attached to the bottom of the stainless steel plate (i.e. opposite the square hollow pipe). The foam pad may be ½ inch to ¾ inch thick and may be attached to stainless steel plate using an adhesive. In one embodiment, a two part epoxy glue is used to attach foam pad to the stainless steel plate.

A plurality of holes (140) are drilled through the foam pad, stainless steel plate and square hollow pipe. Coating material is pumped through pipe (100) into square hollow pipe (110). The coating material flows through the holes distributing coating to the foam pad for application to the surface being coated. The plurality of holes may have a diameter of ⅛ inch and they may be separated by 1½ inch to 1¾ inches center to center.

As will be apparent to those skilled in the art, the dimensions of the various components of the application tool described above are for a particular embodiment of the device, and the dimensions may be varied as desired for a particular coating application. For example, in other embodiments, the pipe (100) may be any dimension between ¼ inch and 1 inch as desired. The plate (120) may vary in length from between 3 inches to 18 inches, and the width may be between 3 inches to 8 inches. The holes through the hollow chamber, application pad and the plate may be any desired size from ⅛ inch to ¾ inches in diameter. In addition, although the plate is typically flat, the plate may have a concave or convex shape if desired.

As discussed previously, any appropriate system for pumping or pushing the liquid coating material through the application tool may be used.

Any appropriate coating material that can flow through the application tool may be used. In one embodiment, a two part epoxy, such as Bio-Dur from Thin Film Technologies is used.

It will be understood by those skilled in the art that numerous modifications can be made to the embodiments described herein. For example, the dimensions of the parts of the application tool may be varied or different materials may be used. Accordingly, the embodiments discussed herein are illustrative rather than limiting in nature.

We claim:

1. A tool for application of a coating material underwater comprising:
(a) a hollow tube fixedly attached to a hollow chamber with an opening to allow liquid to flow through the hollow tube into the hollow chamber;
(b) a plate fixedly attached to the hollow chamber opposite the hollow tube; and
(c) a coating application pad fixedly attached to the plate on the side opposite the hollow chamber, wherein a plurality of holes are drilled through the coating application pad, the plate and the hollow chamber to allow liquid to flow from the hollow chamber to the surface of the application pad.

2. The tool of claim 1, wherein the hollow tube has a threaded end.

3. The tool of claim 2, wherein the hollow tube is a stainless steel pipe.

4. The tool of claim 3, wherein the hollow chamber and the plate are stainless steel.

5. The tool of claim 1, wherein the application pad is foam rubber.

6. The tool of claim 5, wherein the application pad is fixed to the plate with an adhesive.

7. The tool of claim 6, wherein the adhesive is a two part epoxy glue.

8. The tool of claim 1, wherein the hollow tube is attached to the hollow chamber at an angle of 30° to 40°.

9. The tool of claim 1, wherein the plate is one of concave or convex.

10. A tool for application of a coating material underwater comprising:
(a) a ¾ inch diameter stainless steel pipe fixedly attached to a ½ inch by ½ inch square hollow stainless steel chamber with an opening to allow liquid to flow through the pipe into the hollow chamber;
(b) a stainless steel plate fixedly attached to the square hollow chamber opposite the pipe; and
(c) a coating application pad fixedly attached to the plate on the side opposite the square hollow chamber, wherein a plurality of holes are drilled through the coating application pad, the plate and the square hollow chamber to allow liquid to flow from the square hollow chamber to the surface of the application pad.

11. The tool of claim 10, wherein the stainless steel plate has a length between 3 inches and 18 inches and a width between 3 inches and 8 inches.

12. The tool of claim 11, wherein the application pad is foam rubber and is attached using an adhesive.

13. The tool of claim 12, wherein the plurality of holes have a diameter of ⅛ inch and are separated by 1½ inch to 1¾ inch center to center.

14. The tool of claim 10, wherein the end of the steel pipe opposite the square hollow chamber is adapted for connection to a system for supplying liquid coating materials to the application tool.
